(19) United States
(12) Patent Application Publication
(10) Pub. No.: US 2014/0351796 A1
(43) Pub. Date: Nov. 27, 2014

(54) ACCESSIBILITY COMPLIANCE TESTING USING CODE INJECTION

(71) Applicant: Microsoft Corporation, Redmond, WA (US)

(72) Inventors: Ethan Gur-esh, Redmond, WA (US); Mahmoud Bassiouny, Bellevue, WA (US); Cheuk Dong, Redmond, WA (US); Adri Verlaan, Seattle, WA (US); Alyssa Levitz, Seattle, WA (US)

(21) Appl. No.: 13/902,500

(22) Filed: May 24, 2013

(51) Int. Cl. G06F 11/36

(52) U.S. Cl. CPC G06F 11/3604
USPC 717/126

(57) ABSTRACT

Web pages are automatically checked for compliance with specified accessibility rules. When accessibility compliance testing is enabled, code to check for accessibility compliance is automatically injected and run to test one or more elements of the web page for accessibility compliance. Once the code is injected, the code is executed to determine the compliance with the specified accessibility rules. All/portion of the elements on the web page may be checked for accessibility compliance. The web page may be checked for accessibility compliance at one or more times. For example, the page may be checked for accessibility compliance upon loading and/or upon changes (e.g. AJAX event) which modifies the page markup. As long as the accessibility compliance testing is enabled, each page that is loaded by a service may be checked for accessibility compliance.

### BACKGROUND

Reading a computer screen can be difficult for visually impaired users. Similarly, listening to audio can be difficult for hearing impaired users. In order to assist these users in navigating computer screens, many different applications and devices have been developed. In order to assist developers in developing web content that is navigable for different users, accessibility standards have been developed. For example, the World Wide Web Consortium's (W3C) HTML standard has been developed to assist HTML developers in developing web pages. These standards help to ensure that users requiring special assistance can experience the site.

Today many site owners and developers test for compliance by installing third party client-side tools (either actual ‘screen readers’ as used by disabled users, or other validation tools) and manually running them against their web sites & content. This approach, however, can be time-consuming and tedious, as well as introducing requirements for specific client-side software (incl. possibly specific versions of browsers, reader software, etc.) to be installed on a user's computing device. Further, there are many sites and applications that do not follow the accessibility standards.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Web pages are automatically checked for compliance with specified accessibility rules. When accessibility compliance testing is enabled (e.g. through selection of a user interface element and the like), code to check for accessibility compliance is automatically injected and run to test one or more elements of the web page. For example, code may be injected into a Document Object Model (DOM) of a web page that tests accessibility compliance. The compliance code may be injected by a server (e.g. web site) in response to a web page being loaded and/or in response to some other event. Once the code is injected, the code is executed to determine the compliance with the specified accessibility rules. All/portion of the elements on the web page may be checked for accessibility compliance using the selected rules. For example, a user may specify what elements and/or type of elements to check for accessibility compliance. The web page may be checked for accessibility compliance at one or more times. For example, the page may be checked for accessibility compliance upon loading and/or upon changes being detected (e.g. Asynchronous JavaScript and XML (AJAX) event) that modify the page markup. As long as the accessibility compliance testing is enabled, each page that is loaded may be checked for accessibility compliance.

### BRIEF DESCRIPTION OF THE DRAWINGS

FIG. 1 shows a system for accessibility compliance testing using code injection;

FIG. 2 shows example displays for configuring accessibility checks and displaying errors;

FIG. 3 shows example accessibility checks that may be performed;

FIG. 4 shows an illustrative process for accessibility checking web pages using injected code;

FIG. 5 illustrates an architecture for performing accessibility checks;

FIG. 6 illustrates an exemplary online service that may test web pages for accessibility compliance; and

FIGS. 7, 8A, 8B, and 9 and the associated descriptions provide a discussion of a variety of operating environments in which embodiments of the invention may be practiced.

### DETAILED DESCRIPTION

Referring now to the drawings, in which like numerals represent like elements, various embodiment will be described.

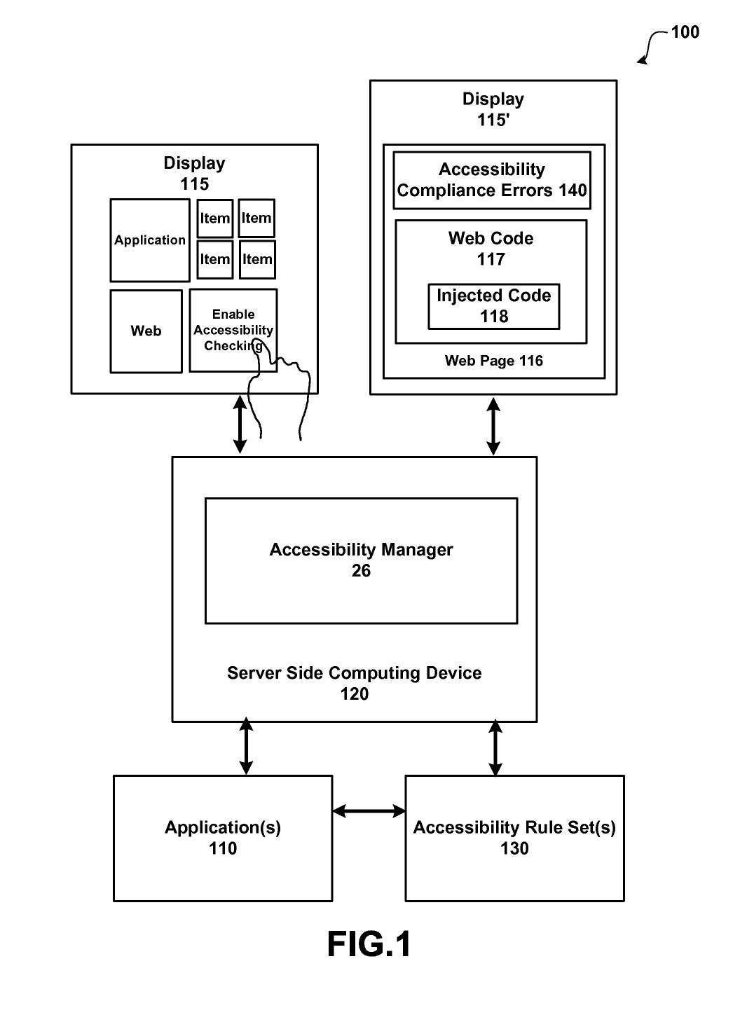

FIG. 1 shows a system for accessibility compliance testing using code injection. As illustrated, system 100 includes application program(s) 110, server side computing device 120, accessibility manager 26 and display 115 that is associated with a computing device (e.g. a touch screen input computing device or some other computing device).

In order to facilitate communication with the accessibility manager 26, one or more callback routines, may be implemented. Application(s) 110 may be a variety of applications, such as business productivity applications, entertainment applications, music applications, travel applications, video applications, and the like. Generally, application(s) 110 may be any application that receives user input to execute a command. The application(s) 110 may be configured to receive different types of input (e.g. speech input, touch input, keyboard input (e.g. a physical keyboard and/or SIP) and/or other types of input as well as output different types of output. According to an embodiment, one or more of the applications use one or more web pages. For example, a web browser may interact with a service using a web pages developed using one or more web programming languages (e.g. eXtensible Markup Language (XML), HyperText Markup Language (HTML), Javascript, Active Server Pages (ASP), VBscript, and the like).

System 100 as illustrated comprises a display 115 that detects when a touch input has been received (e.g. a finger touching or nearly touching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

A user may tap to select a user interface element, perform a stretch gesture to zoom in, and the like. Gestures may include, but are not limited to: a pinch gesture; a stretch gesture; a select gesture (e.g. a tap action on a displayed element); a select and hold gesture (e.g. a tap and hold gesture received on a displayed element); a swiping action and/or dragging action and/or double tap; and the like.

Accessibility manager 26 is configured to perform operations relating to testing web pages for accessibility compliance (e.g. defined accessibility rules, accessibility guidelines, standards, and the like). According to an embodiment, accessibility manager 26 tests compliance with accessibility standards as defined by W3C (e.g. HTLM accessibility standards). While accessibility manager 26 is shown within server side computing device 120, manager 26 may be located in other locations (e.g. within an online service, within an application, within an operating system, within a web browser, and the like).

Web pages, such as web page 116, are automatically checked for compliance with one or more specified accessibility rule set(s). According to an embodiment, web pages are checked for accessibility compliance when accessibility compliance testing is enabled and are not checked when accessibility compliance testing is disabled. For example, a user may enable/disable accessibility compliance testing by selecting a user interface element as illustrated on display 115 and/or through some other method (e.g. selecting a menu, saying a command, selecting a link, . . . ).

When accessibility compliance testing is enabled, code to check for accessibility compliance, such as injected code 118, is automatically injected into a web page, such as web page 118. For example, code may be injected into a Document Object Model (DOM) of a web page that tests accessibility compliance. The compliance code may be injected by a service, a server (e.g. server side computing device 120), or some other computing device in response to a web page being loaded and/or in response to some other event (e.g. AJAX event, web code 117 changing, . . . ). Once the code 118 is injected, the code is executed to determine the compliance using the specified accessibility rules. All/portion of the elements on the web page may be checked for accessibility compliance. For example, a user may specify what elements and/or type of elements to check for accessibility compliance as well as what accessibility to test against the determined elements. The specified rules/elements may be stores in an accessibility rule set (e.g. accessibility rule set 130). Instead of checking each element of a web page with each accessibility rule, accessibility compliance checking may be limited to the elements of concern and the rules of concern. In this way, errors are reported for elements and accessibility rules of interest without reporting errors for elements and/or accessibility rules that are not of interest.

A web page may be checked for accessibility compliance at one or more times. The web page may be checked for accessibility compliance upon loading and/or upon changes (e.g. AJAX event, or client side event, . . . ) which modifies the page markup. As long as the accessibility compliance testing is enabled, each page that is loaded is checked. For example, if a user selects a link on a web page being tested that changes the web page and/or loads another page, the modified page and/or new page is checked for accessibility compliance. One or more accessibility rules and rule sets may be configured to define how to check for accessibility. More details and examples are provided below.

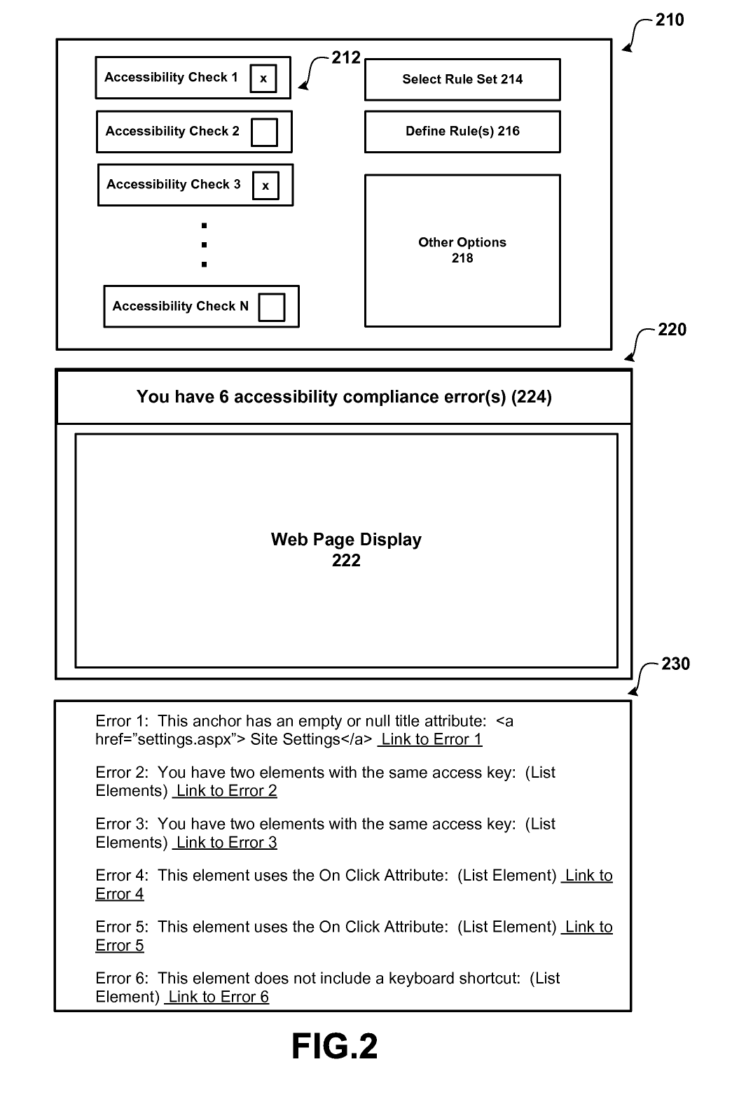

FIG. 2 shows example displays for configuring accessibility checks and displaying errors.

Display 210 illustrates an example Graphical User Interface (GUI) that may be used to select different accessibility checks. A GUI, such as shown in display 210, may be used to configure/select accessibility rules that are used to check for accessibility compliance for one or more web pages.

As illustrated, display 201 includes options 212 for selecting/deselecting one or more accessibility rules. For example, a user (e.g. developer, tester, administrator, . . . ) may select accessibility check 1 and accessibility check 3 to run against one or more web pages and one or more elements in each of the tested web pages. Instead of having to run each accessibility rule that is defined, a user may select the desired rules. A user may also select a different rule set (214), define one or more accessibility check rules (216), as well as possibly selecting other options relating to accessibility compliance checking (e.g. selecting an accessibility standard to follow, looking up government regulations relating to accessibility, defining elements to test, and the like).

Display 220 shows an example web page being checked for accessibility compliance using injected code. As illustrated, display 220 shows the web page display 222 that shows the content currently being navigated and an error display 224 that shows a user when the web page being navigated includes accessibility compliance errors. While error display 224 is illustrated near the top of display 220, the error display may be displayed in different ways, such as: in another window, at another location within the display, or it might be logged, and the like. Accessibility compliance errors may also be shown with the web page display. For example, when an element is detected to have an accessibility compliance error, that element may be shown differently (e.g. highlighted, additional information showing the error, . . . ). According to an embodiment, a user may select error display 224 to view the errors in more detail. For example, see display 230.

Display 230 shows an example accessibility error display showing more detail for the errors. As illustrated, displays 230 shows each detected error along with information relating to the error. As shown, the display includes a type of the error, the element(s) associated with the error and a link to the error that when selected may navigate the user to the web code. More/less information relating to the errors may be included in display 230.

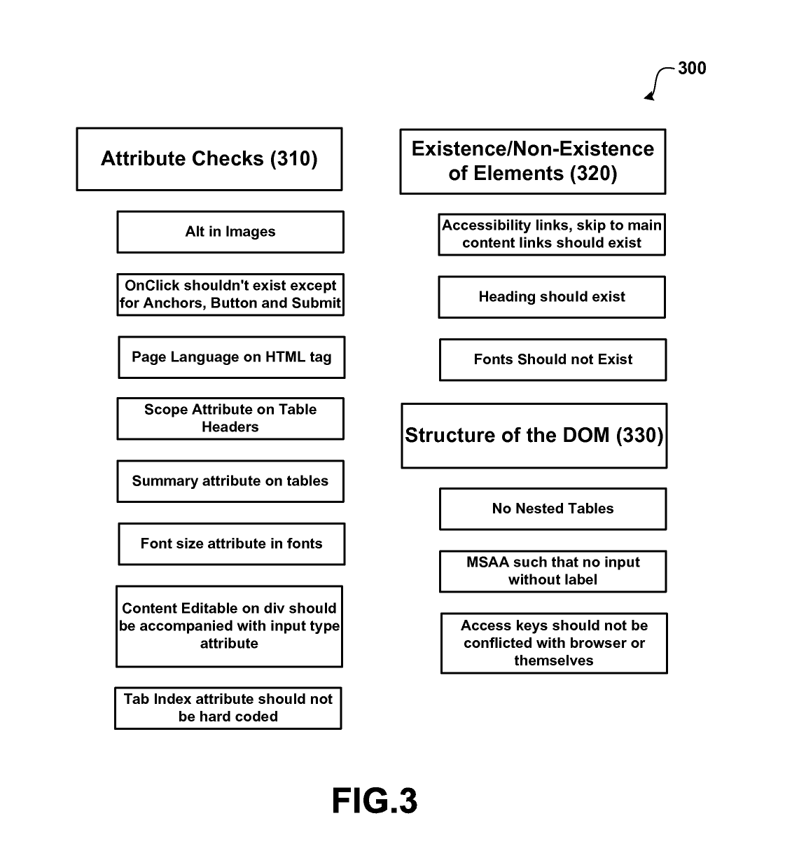

FIG. 3 shows example accessibility checks 300 that may be performed. As illustrated, accessibility checks includes attribute checks 310, existence/non-existence of elements 320 and structure of the Document Object Model (DOM) 330. FIG. 3 is for illustrative purposes and is not intended to be limiting. More/fewer accessibility checks may be configured/performed.

Attribute checks 310 includes different accessibility compliance checks for determining when attributes associated with elements include information as defined by accessibility rules. Some example attribute checks include: Alt in Images; OnClick should not exist except for Anchors, Button and Submit; Page Language on HTML tag; Scope Attribute on Table Headers; Summary attribute on tables; Font size attribute in fonts; Content Editable on div should be accompanied with input type attribute; and Tab Index attribute should not be hard coded.

Existence/non-existence of elements 320 includes different accessibility compliance checks for determining when elements in the web page are either detected (when they should not be included as defined by accessibility rules) and/or not detected (when they should be included as defined by accessibility rules). Some example element existence checks include: Accessibility links, skip to main content links should exist; Heading should exist; and Fonts Should not Exist.

Structure of the DOM 320 includes different accessibility compliance checks for determining when elements in the web page are properly structured as defined by accessibility rules. Some example structure checks include: No Nested Tables; Microsoft Active Accessibility (MSAA) such that no input without label; and Access keys should not be conflicted with browser or themselves.

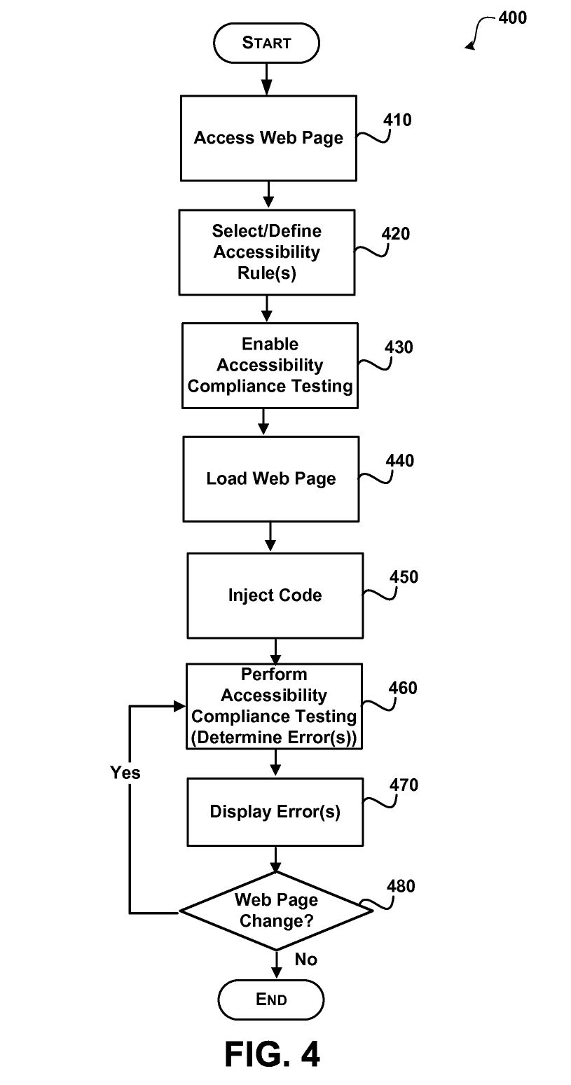

FIG. 4 shows an illustrative process for accessibility checking web pages using injected code. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

After a start operation, the process moves to operation 410, where one or more web pages are accessed. The web page(s) may be existing web pages and/or web pages currently being developed and tested. According to an embodiment, the web pages are coded using a markup language, such as HTML or XML. Other languages may also be used (e.g. Javascript, . . . ).

Moving to operation 420, the accessibility rules to apply to one or more web pages are selected and/or defined. The rules may be defined to include as many/few rules as desired. For example, a user may select an accessibility rule to help ensure that each element includes a text equivalent for each non-text element (e.g., images, graphical representations of text (including symbols), videos, animations, applets and programmatic objects, ASCII art, frames, scripts, sounds, and the like. A user may also select an accessibility rule that checks that keyboard shortcuts are included for navigating links and/or form controls on a page. One or more rule sets may be stored for later use. For example, a user may select a previously configured rule set. According to an embodiment, a user may utilize a GUI (or any other form of interface) to configure/select the accessibility rules.

Flowing to operation 430, accessibility compliance testing is enabled. For example, a user may enable/disable accessibility compliance testing by selecting a user interface element and/or through some other method (e.g. selecting a menu, saying a command, selecting a link, . . . ). Accessibility compliance testing may be automatically enabled according to different events. For example, accessibility compliance testing may be automatically enabled when a page is identified to be under development and/or before a product release, within a predetermined time range (e.g. between April 20^{th} and April 22^{nd}), and the like.

Transitioning to operation 440, a web page is loaded. According to an embodiment, a document object model (DOM) is created that includes each of the elements defined by the web page.

Flowing to operation 450, code for accessibility compliance checking is automatically injected into the loaded web page when accessibility compliance testing is enabled. For example, the code may be injected into a Document Object Model (DOM) of the web page. According to an embodiment, the injected code is JavaScript. The compliance code may be injected by a service, a server, or some other computing device in response to a web page being loaded and/or in response to some other event (e.g. AJAX event, web code changing, . . . ).

Moving to operation 460, the accessibility compliance testing for the web page is performed. According to an embodiment, each element in the web page is checked against each of the selected accessibility rules. For example, the DOM tree for the web page is walked and each element is inspected to determine its compliance with each of the selected rules. When a rule is violated, the error is stored.

Flowing to operation 470, the determined errors are displayed. The display may include each error and/or a summary of errors. According to an embodiment, an overview of the errors is displayed near a top of the web page being navigated. More detailed information about the errors may be obtained by a user by selecting a user interface element.

Transitioning to decision operation 480, a determination is made as to whether the web page has changed. For example, a user have selected an element that changes a structure/content of the web page and/or some other action caused the web page to change. When the web page changes, the process returns to operation 460 where the updated web page is checked again for accessibility compliance. In some cases, code may be injected to test for different elements in the changed web page. When the web page does not change, the process flows to an end operation and returns to process other operations.

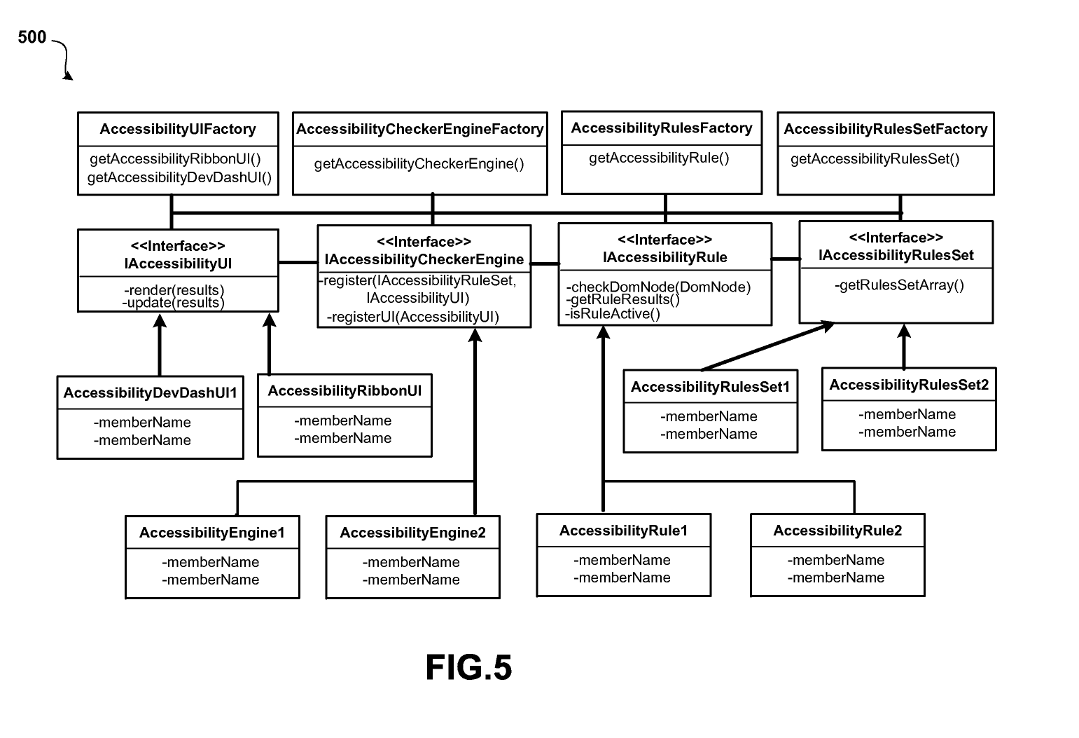

FIG. 5 illustrates an architecture for performing accessibility checks. As illustrated, architecture 500 includes the following classes: AccessibilityUIFactory, AccessibilityCheckerEngineFactory; AccessibilityRulesFactory; and AccessibilityRulesSetFactory. Interfaces shown in architecture 500 include: IAccessibilityUI; IAccessibilityCheckerEngine; IAccessibilityRule; and IAccessibilityRulesSet. Architecture 500 also includes AccessibilityDevDashUI1; AccessibilityRibbonUI; AccessibilityRulesSet1; AccessibilityRulesSet2; AccessibilityEngine1; AccessibilityEngine2; AccessibilityRule1 and AccessibilityRule2.

Architecture 500 utilizes a creational pattern referred to as the Factory Design Pattern. According to an embodiment, the Factory Design Pattern is used in a MICROSOFT .NET Framework. The factory pattern uses a specialized object to create other objects, much like a real-world factory. As with other design patterns, there are countless variations of the Factory pattern, although variants typically use the same set of primary actors, a client, a factory, and a product. The client is an object that uses an instance of another object (the product) for some purpose. Rather than creating the product instance directly, the client delegates this responsibility to the factory. Once invoked, the factory creates a new instance of the product, passing it back to the client. Put simply, the client uses the factory to create an instance of the product.

The AccessibilityCheckerEngineFactory class is the factory used for creating an AccessibilityCheckerEngine interface that can be implemented by different methods. According to an embodiment, there is one implementation of the engine such that the factory simply creates instance of this class that can be extended later by other implementations. This the same for the AccessibilityRulesFactory, AccessibilityRulesSetFactory and AccessibilityUIFactory. Using this design, Engines; Rules; Rules Sets to be applied; and UIs may be added/changed without affecting the architecture around it.

The developer registers the accessibility rules set and the UI to the engine. According to an embodiment, the engine attaches the event handlers on the document load and DOM change, iterates through each DOM node and sends to each rule in the registered rules' set the DOM node to validate, and keeps information about it if needed. The engine calls each rule to obtain its results from the accessibility testing and aggregates the results and passes the results to the registered UI to render them. The controller is the interaction between the UI and the model, the main function of the controller is to instantiate engine, rules set and UI objects, and then register the rules set and UI to the engine.

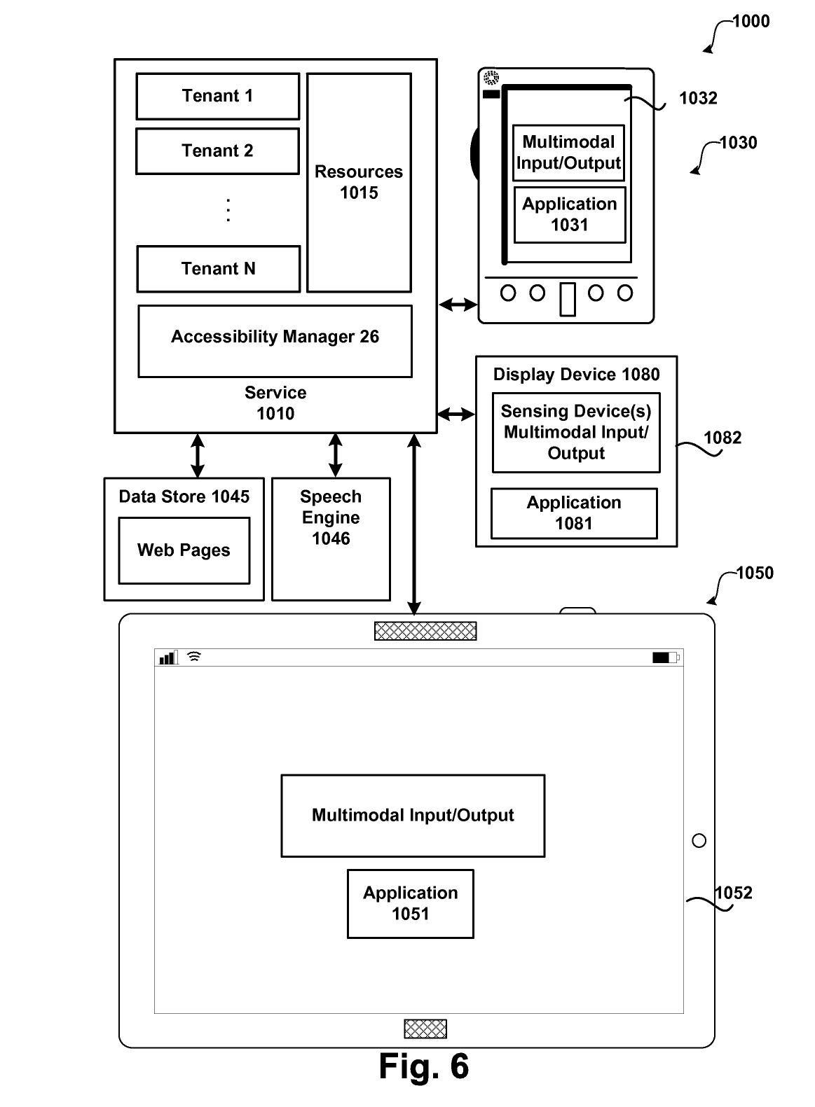

FIG. 6 illustrates an exemplary online service that may test web pages for accessibility compliance. As illustrated, system 1000 includes service 1010, data store 1045, speech engine 1046, touch screen input device 1050 (e.g. a slate), smart phone 1030, and display device 1080 (e.g. monitor/television, . . . ).

Each device (e.g. device 1050, smart phone 1030, display device) may be configured to receive input from one or more sensing devices. The sensing device may be a part of the device and/or separate from the device. The sensing device may be configured to capture user input using various input methods. A sensing device may include one or more microphones to capture spoken input (e.g. words) and one or more cameras to detect movement of a user (e.g. pictures/videos). The sensing device may also be configured to capture other inputs from a user such as by a keyboard and/or mouse (not pictured). For example, the sensing device may be a MICROSOFT KINECT® device comprising a plurality of cameras and a plurality of microphones

As illustrated, service 1010 is a cloud based and/or enterprise based service that may be configured to provide one or more services. The service may be configured to be interacted with using different types of input/output. For example, a user may use speech input, touch input, hardware based input, and the like. The service may provide speech output and/or sound effects. Functionality of one or more of the services/applications provided by service 1010 may also be configured as a client/server based application.

As illustrated, service 1010 is a multi-tenant service that provides resources 1015 and services to any number of tenants (e.g. Tenants 1−N). Multi-tenant service 1010 is a cloud based service that provides resources/services 1015 to tenants subscribed to the service and maintains each tenant's data separately and protected from other tenant data.

System 1000 as illustrated comprises a touch screen input device 1050 (e.g. a slate/tablet device) and smart phone 1030 that detects when a touch input has been received (e.g. a finger touching or nearly touching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

According to an embodiment, smart phone 1030, touch screen input device 1050 and display device 1080 may be configured with multimodal applications (1031, 1051, 1081). While the application is illustrated as part of the device, the application may be a network application (e.g. included as part of service 1010) that is stored externally from the device.

As illustrated, touch screen input device 1050, smart phone 1030 and display device 1080 shows exemplary displays 1052/1032/1082 showing the use of an application that utilize web pages that may be tested for accessibility compliance. Data may be stored on a device (e.g. smart phone 1030, slate device 1050 and/or at some other location (e.g. network data store 1045). Data store 1045 may be used to store content, such as web pages associated with service 1010. The applications used by the devices may be client based applications, server based applications, cloud based applications and/or some combination.

Accessibility manager 26 is configured to perform operations relating to accessibility compliance testing as described herein. While manager 26 is shown within service 1010, the all/part of the functionality of the manager may be included in other locations (e.g. on smart phone 1030, slate device 1050 and/or display device 1080).

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

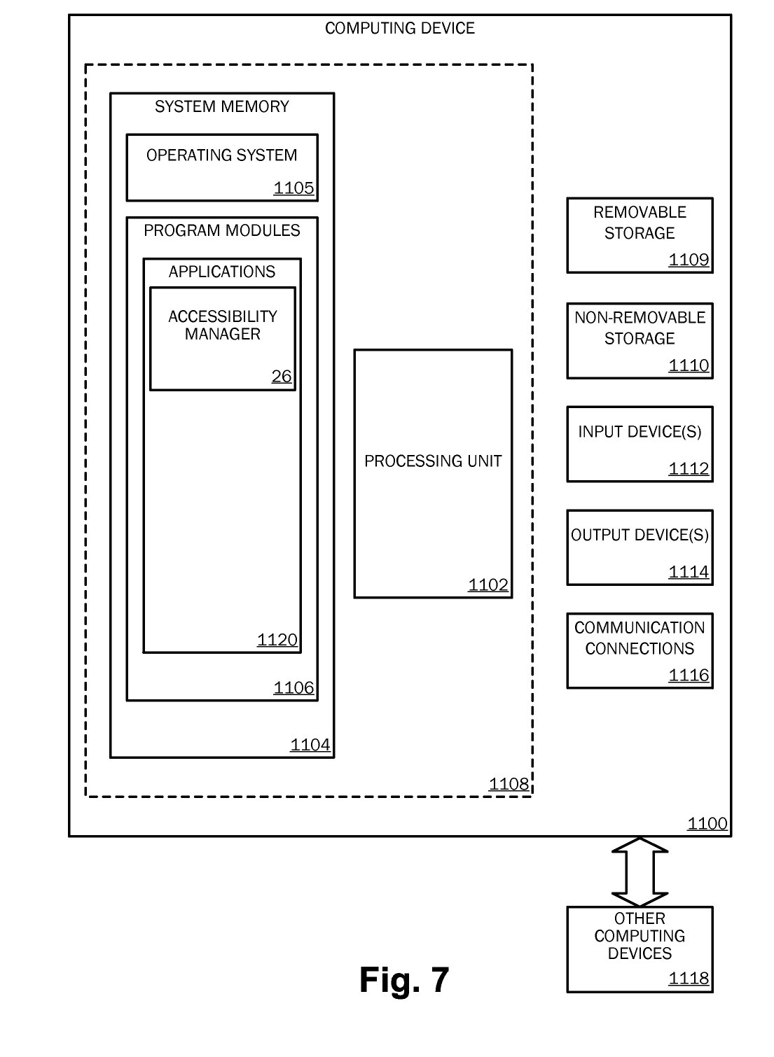

FIGS. 7-9 and the associated descriptions provide a discussion of a variety of operating environments in which embodiments of the invention may be practiced. However, the devices and systems illustrated and discussed with respect to FIGS. 7-9 are for purposes of example and illustration and are not limiting of a vast number of computing device configurations that may be utilized for practicing embodiments of the invention, described herein.

FIG. 7 is a block diagram illustrating physical components (i.e., hardware) of a computing device 1100 with which embodiments of the invention may be practiced. The computing device components described below may be suitable for the computing devices described above. In a basic configuration, the computing device 1100 may include at least one processing unit 1102 and a system memory 1104. Depending on the configuration and type of computing device, the system memory 1104 may comprise, but is not limited to, volatile storage (e.g., random access memory), non-volatile storage (e.g., read-only memory), flash memory, or any combination of such memories. The system memory 1104 may include an operating system 1105 and one or more program modules 1106 suitable for running software applications 1120 such as the accessibility manager 26. The operating system 1105, for example, may be suitable for controlling the operation of the computing device 1100. Furthermore, embodiments of the invention may be practiced in conjunction with a graphics library, other operating systems, or any other application program and is not limited to any particular application or system. This basic configuration is illustrated in FIG. 7 by those components within a dashed line 1108. The computing device 1100 may have additional features or functionality. For example, the computing device 1100 may also include additional data storage devices (removable and/or non-removable) such as, for example, magnetic disks, optical disks, or tape. Such additional storage is illustrated in FIG. 7 by a removable storage device 1109 and a non-removable storage device 1110.

As stated above, a number of program modules and data files may be stored in the system memory 1104. While executing on the processing unit 1102, the program modules 1106 (e.g., the accessibility manager 26) may perform processes including, but not limited to, one or more of the stages of the methods and processes illustrated in the figures. Other program modules that may be used in accordance with embodiments of the present invention may include electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the accessibility manager 26 may be operated via application-specific logic integrated with other components of the computing device 1100 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 1100 may also have one or more input device(s) 1112 such as a keyboard, a mouse, a pen, a sound input device, a touch input device, etc. The output device(s) 1114 such as a display, speakers, a printer, etc. may also be included. The aforementioned devices are examples and others may be used. The computing device 1100 may include one or more communication connections 1116 allowing communications with other computing devices 1118. Examples of suitable communication connections 1116 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1104, the removable storage device 1109, and the non-removable storage device 1110 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1100. Any such computer storage media may be part of the computing device 1100. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

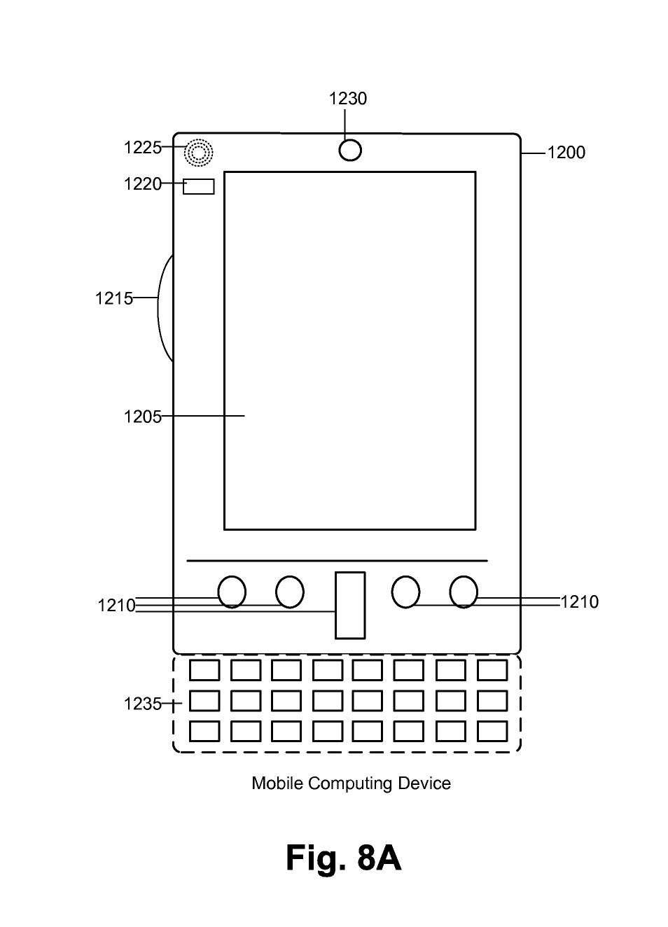

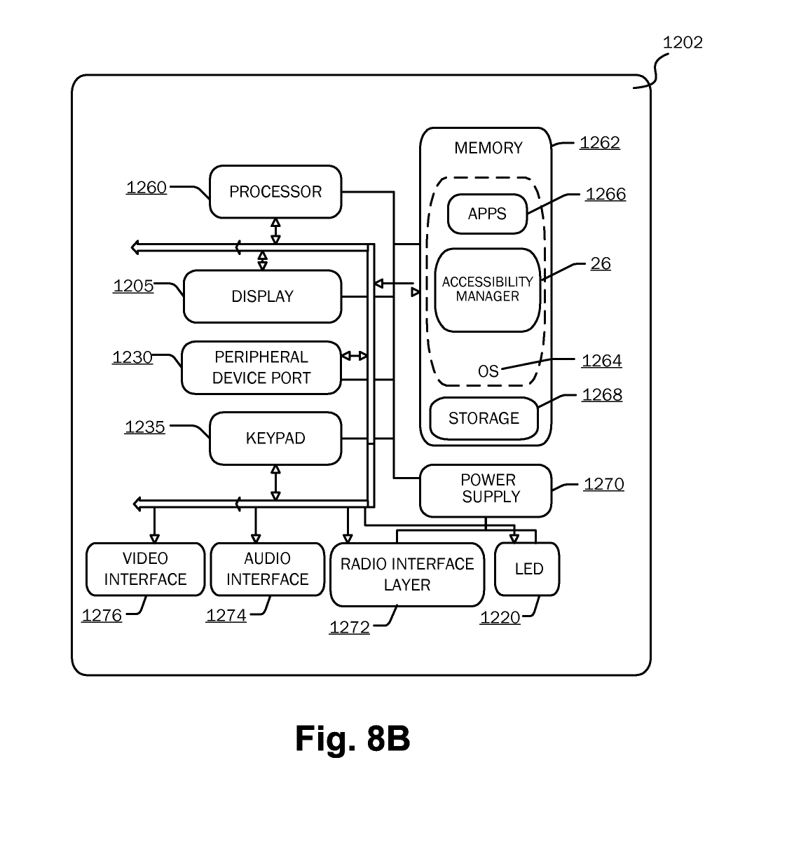

FIGS. 8A and 8B illustrate a mobile computing device 1200, for example, a mobile telephone, a smart phone, a tablet personal computer, a laptop computer, and the like, with which embodiments of the invention may be practiced. With reference to FIG. 8A, one embodiment of a mobile computing device 1200 for implementing the embodiments is illustrated. In a basic configuration, the mobile computing device 1200 is a handheld computer having both input elements and output elements. The mobile computing device 1200 typically includes a display 1205 and one or more input buttons 1210 that allow the user to enter information into the mobile computing device 1200. The display 1205 of the mobile computing device 1200 may also function as an input device (e.g., a touch screen display). If included, an optional side input element 1215 allows further user input. The side input element 1215 may be a rotary switch, a button, or any other type of manual input element. In alternative embodiments, mobile computing device 1200 may incorporate more or less input elements. For example, the display 1205 may not be a touch screen in some embodiments. In yet another alternative embodiment, the mobile computing device 1200 is a portable phone system, such as a cellular phone. The mobile computing device 1200 may also include an optional keypad 1235. Optional keypad 1235 may be a physical keypad or a “soft” keypad generated on the touch screen display. In various embodiments, the output elements include the display 1205 for showing a graphical user interface (GUI), a visual indicator 1220 (e.g., a light emitting diode), and/or an audio transducer 1225 (e.g., a speaker). In some embodiments, the mobile computing device 1200 incorporates a vibration transducer for providing the user with tactile feedback. In yet another embodiment, the mobile computing device 1200 incorporates input and/or output ports, such as an audio input (e.g., a microphone jack), an audio output (e.g., a headphone jack), and a video output (e.g., a HDMI port) for sending signals to or receiving signals from an external device.

FIG. 8B is a block diagram illustrating the architecture of one embodiment of a mobile computing device. That is, the mobile computing device 1200 can incorporate a system (i.e., an architecture) 1202 to implement some embodiments. In one embodiment, the system 1202 is implemented as a “smart phone” capable of running one or more applications (e.g., browser, e-mail, calendaring, contact managers, messaging clients, games, and media clients/players). In some embodiments, the system 1202 is integrated as a computing device, such as an integrated personal digital assistant (PDA) and wireless phone.

One or more application programs 1266 may be loaded into the memory 1262 and run on or in association with the operating system 1264. Examples of the application programs include phone dialer programs, e-mail programs, personal information management (PIM) programs, word processing programs, spreadsheet programs, Internet browser programs, messaging programs, and so forth. The system 1202 also includes a non-volatile storage area 1268 within the memory 1262. The non-volatile storage area 1268 may be used to store persistent information that should not be lost if the system 1202 is powered down. The application programs 1266 may use and store information in the non-volatile storage area 1268, such as e-mail or other messages used by an e-mail application, and the like. A synchronization application (not shown) also resides on the system 1202 and is programmed to interact with a corresponding synchronization application resident on a host computer to keep the information stored in the non-volatile storage area 1268 synchronized with corresponding information stored at the host computer. As should be appreciated, other applications may be loaded into the memory 1262 and run on the mobile computing device 1200, including the accessibility manager 26 as described herein.

The system 1202 has a power supply 1270, which may be implemented as one or more batteries. The power supply 1270 might further include an external power source, such as an AC adapter or a powered docking cradle that supplements or recharges the batteries.

The system 1202 may also include a radio 1272 that performs the function of transmitting and receiving radio frequency communications. The radio 1272 facilitates wireless connectivity between the system 1202 and the “outside world,” via a communications carrier or service provider. Transmissions to and from the radio 1272 are conducted under control of the operating system 1264. In other words, communications received by the radio 1272 may be disseminated to the application programs 1266 via the operating system 1264, and vice versa.

The visual indicator 1220 may be used to provide visual notifications, and/or an audio interface 1274 may be used for producing audible notifications via the audio transducer 1225. In the illustrated embodiment, the visual indicator 1220 is a light emitting diode (LED) and the audio transducer 1225 is a speaker. These devices may be directly coupled to the power supply 1270 so that when activated, they remain on for a duration dictated by the notification mechanism even though the processor 1260 and other components might shut down for conserving battery power. The LED may be programmed to remain on indefinitely until the user takes action to indicate the powered-on status of the device. The audio interface 1274 is used to provide audible signals to and receive audible signals from the user. For example, in addition to being coupled to the audio transducer 1225, the audio interface 1274 may also be coupled to a microphone to receive audible input, such as to facilitate a telephone conversation. In accordance with embodiments of the present invention, the microphone may also serve as an audio sensor to facilitate control of notifications, as will be described below. The system 1202 may further include a video interface 1276 that enables an operation of an on-board camera 1230 to record still images, video stream, and the like.

A mobile computing device 1200 implementing the system 1202 may have additional features or functionality. For example, the mobile computing device 1200 may also include additional data storage devices (removable and/or non-removable) such as, magnetic disks, optical disks, or tape. Such additional storage is illustrated in FIG. 8B by the non-volatile storage area 1268.

Data/information generated or captured by the mobile computing device 1200 and stored via the system 1202 may be stored locally on the mobile computing device 1200, as described above, or the data may be stored on any number of storage media that may be accessed by the device via the radio 1272 or via a wired connection between the mobile computing device 1200 and a separate computing device associated with the mobile computing device 1200, for example, a server computer in a distributed computing network, such as the Internet. As should be appreciated such data/information may be accessed via the mobile computing device 1200 via the radio 1272 or via a distributed computing network. Similarly, such data/information may be readily transferred between computing devices for storage and use according to well-known data/information transfer and storage means, including electronic mail and collaborative data/information sharing systems.

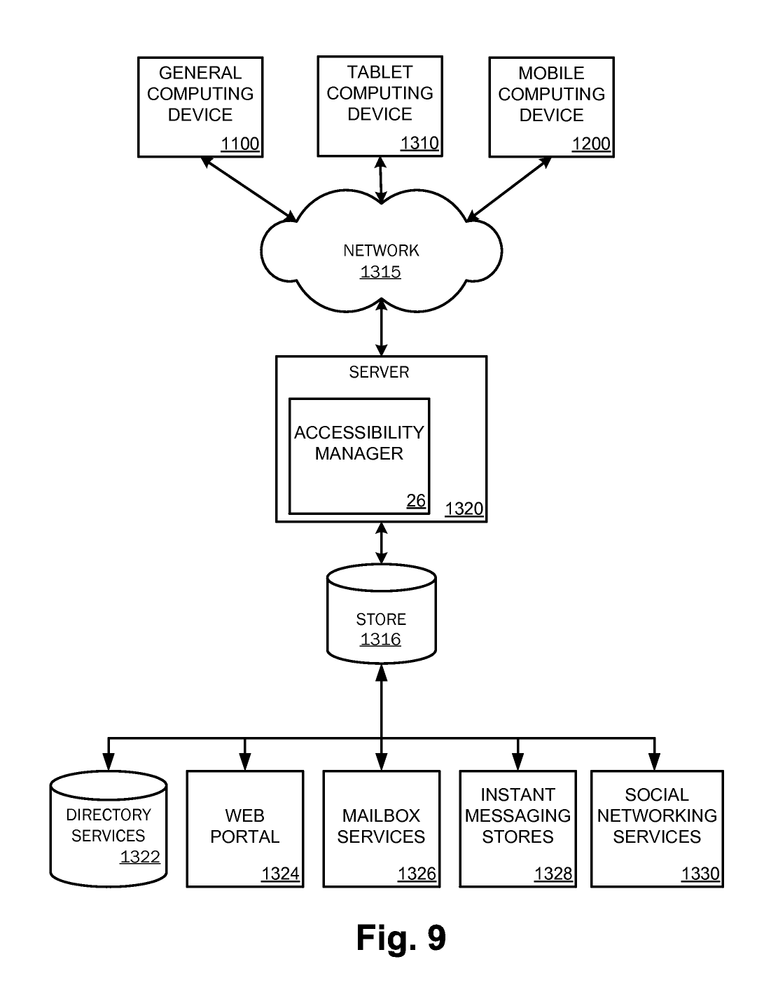

FIG. 9 illustrates an embodiment of an architecture of a system for accessibility compliance testing, as described above. Content developed, interacted with, or edited in association with the accessibility manager 26 may be stored in different communication channels or other storage types. For example, various documents may be stored using a directory service 1322, a web portal 1324, a mailbox service 1326, an instant messaging store 1328, or a social networking site 1330. The accessibility manager 26 may use any of these types of systems or the like for enabling data utilization, as described herein. A server 1320 may provide the accessibility manager 26 to clients. As one example, the server 1320 may be a web server providing the accessibility manager 26 over the web. The server 1320 may provide the accessibility manager 26 over the web to clients through a network 1315. By way of example, the client computing device may be implemented as the computing device 1100 and embodied in a personal computer, a tablet computing device 1310 and/or a mobile computing device 1200 (e.g., a smart phone). Any of these embodiments of the client computing device 1100, 1310, 1200 may obtain content from the store 1316.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

What is claimed is:

1. A method for accessibility compliance testing, comprising:
accessing a web page that includes elements;
automatically injecting code into the web page that when executed performs accessibility compliance testing;
automatically executing the injected code to perform the accessibility compliance testing on at least a portion of the elements on the web page; and
providing information about accessibility errors determined from the accessibility compliance testing.

2. The method of claim 1, further comprising loading an accessibility rule set comprising rules that define what accessibility rules to use when performing the accessibility compliance testing.

3. The method of claim 1, further comprising receiving a selection of rules used when performing the accessibility compliance testing.

4. The method of claim 1, further comprising determining when accessibility compliance is enabled, and when enabled automatically performing the accessibility compliance testing for each web page that is loaded while the accessibility compliance is enabled.

5. The method of claim 1, wherein automatically injecting the code into the web page occurs in response to the web page being loaded.

6. The method of claim 1, further comprising automatically executing the injected code to perform the accessibility compliance testing on at least a portion of the elements on the web page in response to determining that the web page changed.

7. The method of claim 1, wherein providing information about the accessibility errors comprises displaying a warning indicating that errors occurred while web page content continues to be displayed and is navigable.

8. The method of claim 7, wherein providing information about the accessibility errors comprises displaying detailed information about each of the errors including each element and error.

9. The method of claim 1, wherein providing information about the accessibility errors further comprising displaying a link with the error that provides an indication to a location of the error.

10. A computer-readable medium storing computer-executable instructions for accessibility compliance testing, comprising:
loading a web page that includes elements;
automatically injecting code into the web page that when executed performs accessibility compliance testing;
automatically executing the injected code to perform the accessibility compliance testing on at least a portion of the elements on the web page while the web page is being displayed and is navigable; and
displaying information about accessibility errors determined from the accessibility compliance testing with a display of the web page.

11. The computer-readable medium of claim 10, further comprising loading accessibility rules that are applied to the at least the portion of the elements when performing the accessibility compliance testing.

12. The computer-readable medium of claim 10, further comprising receiving a selection of accessibility rules used before performing the accessibility compliance testing.

13. The computer-readable medium of claim 10, further comprising receiving a selection to enable accessibility compliance and while the accessibility compliance is enabled automatically performing the accessibility compliance testing for each web page that is loaded.

14. The computer-readable medium of claim 10, further comprising automatically executing the injected code to perform the accessibility compliance testing in response to determining that the web page changed in response to a selection being received on the web page.

15. The computer-readable medium of claim 10, wherein providing information about the accessibility errors comprises displaying a summary of accessibility errors determined and continuing to display the web page.

16. A system for accessibility compliance testing, comprising:
a display that is configured to receive touch input;
a processor and memory;
an operating environment executing using the processor;
a display showing content; and
an accessibility manager that is configured to perform actions comprising:
loading a web page that includes elements;
automatically injecting code into the web page that when executed performs accessibility compliance testing;
automatically executing the injected code to perform the accessibility compliance testing on at least a portion of the elements on the web page while the web page is being displayed and is navigable; and
displaying information about accessibility errors determined from the accessibility compliance testing with a display of the web page.

17. The system of claim 16, further comprising loading accessibility rules that are applied to the at least the portion of the elements when performing the accessibility compliance testing.

18. The system of claim 16, further comprising receiving a selection of accessibility rules used before performing the accessibility compliance testing.

19. The system of claim 16, further comprising receiving a selection to enable accessibility compliance and while the accessibility compliance is enabled automatically performing the accessibility compliance testing for each web page that is loaded.

20. The system of claim 16, further comprising automatically executing the injected code to perform the accessibility compliance testing in response to determining that the web page changed in response to a selection being received on the web page.
